(19) United States
(12) Patent Application Publication
(10) Pub. No.: US 2004/0037475 A1
(43) Pub. Date: Feb. 26, 2004

(54) Method and apparatus for processing annotated screen capture images by automated selection of image regions

(76) Inventors: Gopal B. Avinash, New Berlin, WI (US); Pinaki Ghosh, Bangalore (IN)

Correspondence Address: OSTRAGER CHONG & FLAHERTY LLP, 825 THIRD AVE, 30TH FLOOR, NEW YORK, NY, 10022-7519, US

(21) Appl. No.: 10/064,873

(22) Filed: Aug. 26, 2002

(51) Int. Cl. G06K 9/20

(52) U.S. Cl. 382/283

(57) ABSTRACT

Methods and systems for automated enhancement of annotated images while maintaining the pristine form of the annotations. The disclosed technique has application in processing of intensity or grayscale images as well as processing of color images. The method for processing a grayscale annotated image comprises the following steps: removing one or more annotations from the annotated image to derive a modified image; processing the modified image using an algorithm to derive a processed image; and merging the removed one or more annotations with the processed image to derive a merged image. In the case of RGB color annotated images, the RGB values are first converted into hue, saturation and value (HSV) components. Then the value (i.e., brightness) component of the resulting HSV image is processed using the disclosed technique.

### BACKGROUND OF INVENTION

OLE_LINK1 This invention generally relates to image enhancement. In particular, the present invention relates to the enhancement of grayscale or color images that contain annotations.

In many applications, such as medical diagnostic imaging, images are saved with annotations burnt in. The annotations are typically burnt in by overlaying an arbitrary intensity value of text on the image. When such images are processed using image processing algorithms, the resulting output image will not maintain the annotations in their pristine form.

For example, in ultrasound imaging, the diagnostic quality of images presented for interpretation may be diminished for a number of reasons, including incorrect settings for brightness and contrast. If one tries to improve the image with available methods for adjusting brightness and contrast, this has the undesirable result of distorting any annotations burnt into the image.

Since the annotations are idealized representations of information, they need to be preserved as such for them to be useful for future reference. In short, there is a need for a method and an apparatus that enable an annotated image to be enhanced without degrading the appearance of the annotations.

### SUMMARY OF INVENTION

The present invention is directed to methods and systems for automated enhancement of annotated images while maintaining the pristine form of the annotations. The invention has application in processing of intensity or grayscale images as well as color images. In the case of RGB color images, the RGB values are first converted into hue, saturation and value (HSV) components. Then the value (i.e., brightness) component of the resulting HSV image is processed.

One aspect of the invention is a method for processing annotated images comprising the following steps: removing one or more annotations from a grayscale annotated image to derive a modified image; processing the modified image using an algorithm to derive a processed image; and merging the removed one or more annotations with the processed image to derive a merged image.

Another aspect of the invention is a computer system programmed to perform the following steps: removing one or more annotations from a grayscale annotated image to derive a modified image; processing the modified image using an algorithm to derive a processed image; merging the removed one or more annotations with the processed image to derive a merged image; and controlling the display monitor to display the merged image.

A further aspect of the invention is a method for processing annotated images comprising the following steps: removing the hue and saturation components from a HSV color annotated image to derive a brightness component annotated image; removing one or more annotations from the brightness component annotated image to derive a modified image; processing the modified image using an algorithm to derive a processed image; merging the removed one or more annotations and the removed hue and saturation components with the processed image to derive a merged image.

Another aspect of the invention is a computer system programmed to perform the following steps: removing the hue and saturation components from an HSV color annotated image to derive a brightness component annotated image; removing one or more annotations from the brightness component annotated image to derive a modified image; processing the modified image using an algorithm to derive a processed image; and merging the removed one or more annotations and the removed hue and saturation components with the processed image to derive a merged image.

Yet another aspect of the invention is a computerized image enhancement system programmed to perform the following steps: receiving a grayscale annotated image;

removing one or more annotations from the annotated image to derive a modified image; processing the modified image using an algorithm to derive an enhanced image; and merging the removed one or more annotations with the enhanced image to derive an annotated enhanced image.

Other aspects of the invention are disclosed and claimed below.

### BRIEF DESCRIPTION OF DRAWINGS

FIG. 1 is a block diagram generally showing an image processing system that can programmed in accordance with one of the embodiments of the present invention.

FIG. 2 is a flowchart generally representing the sequence of steps of an image processing algorithm in accordance with some embodiments of the invention.

FIG. 3 is a flowchart showing a sequence of steps of a morphological processing forming part of the image processing algorithm in accordance with one embodiment of the invention.

FIG. 4 is a flowchart showing a sequence of steps of a connectivity analysis forming part of the image processing algorithm in accordance with another embodiment of the invention.

### DETAILED DESCRIPTION

The present invention is directed to automated processing of annotated images by a computer system. As used herein, the term “computer” means any programmable electronic machine, circuitry or chip that processes data or information in accordance with a program or algorithm. In particular, the term “computer” includes, but is not limited to, a dedicated processor or a general-purpose computer. As used herein, the term “computer system” means a single computer or a plurality of intercommunicating computers.

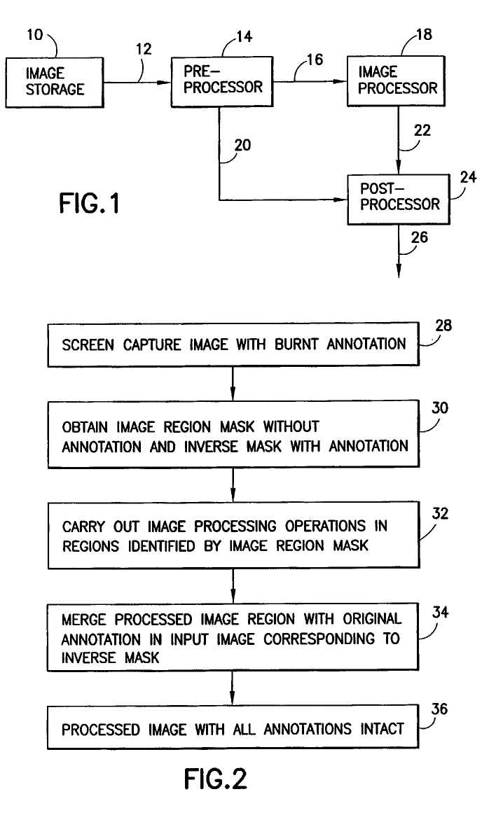

A computer system that can be programmed in accordance with the embodiments of the present invention is depicted in FIG. 1. Images are acquired, for example, by a scanner (not shown), and stored in computer memory 10. For example, computer memory 10 may comprises an image file storage system that is accessed by an image file server (not shown). In particular, a multiplicity of scanners may communicate with an image file server via an LAN or wide-area network, acquiring images at remote sites and storing the acquired images as files in a central memory 10.

FIG. 1 depicts a computer system that comprises an image processor 18 for processing images retrieved from image storage 10. The image processor 18 may comprise a dedicated processor or a separate processing module or computer program of a general-purpose computer. Depending on the particular application, the image processor 18 may be programmed to perform any desired processing of images, such as brightness enhancement, contrast enhancement, image filtering, etc.

In accordance with the embodiment generally depicted in FIG. 1, the computer system further comprises a pre-processor 14 for performing operations on the images 12 retrieved from image storage 10 before image processing, as will be explained in more detail below. The pre-processor 14 outputs pre-processed images 16 to the image processor 18 and pre-processed images 20 to a post-processor 24. The pre-processor 14 may comprise a dedicated processor or a separate processing module or computer program of the same general-purpose computer that includes the image processor 18.

The image processor 18 receives the pre-processed images 16, performs image processing on those images, and outputs the processed images 22 to the post-processor 24. The post-processor 24 is programmed to merge a processed image from image processor 18 with a corresponding pre-processed image from the pre-processor 14, as will be explained in more detail below. The post-processor 14 may comprise a dedicated processor or a separate processing module or computer program of the same general-purpose computer that includes the pre-processor 14 and image processor 18.

In accordance with the embodiments disclosed herein, the computer system shown in FIG. 1 is programmed to process annotated images. The basic steps of the method are as follows: removing one or more annotations from the annotated image to derive a modified image without annotations; processing the modified image using an algorithm, e.g., an image enhancement algorithm, to derive a processed image; and merging the removed one or more annotations with the processed image to derive a merged image.

A method for processing a grayscale annotated image in accordance with some embodiments of the invention is generally depicted in FIG. 2. The process starts with a screen capture image 28 having one or more annotations burnt in the image. As used herein, the term “screen capture” means that the stored image was captured in the data format used for video display on a display screen. The annotated image is retrieved from image storage, as previously described, and then pre-processed in step 30.

Based on the grayscale values on the annotated image, the pre-processor derives one binary mask that defines the image regions and masks out the annotated regions of the image and another binary mask that is the inverse of the image region binary mask. In other words, the inverse binary mask defines the annotated regions and masks out the image regions of the image. The pre-processor then multiplies the original grayscale annotated image and the image region binary mask to derive a first masked image consisting of the image regions of the original image with the annotations removed. The pre-processor also multiplies the original grayscale annotated image and the inverse binary mask to derive a second masked image consisting of the annotated regions with the image regions removed. Referring to FIG. 1, the pre-processor 14 outputs the first masked image 16 to the image processor 18 and outputs the second masked image 20 to the post-processor 24.

Multiplication may be performed by multiplying the pixel intensity values of the original grayscale annotated image times the respective pixel values of the binary mask. As is known to persons skilled in the art of region-based image processing, a binary mask is a binary image having the same size as the image to be processed. The mask contains 1″s for all pixels that are part of the region of interest, and 0″s everywhere else. However, it is not necessary that actual multiplication be performed.

For example, instead of actually deriving the masked image, masked filtering could be used to process the regions of interest only. Masked filtering is an operation that applies filtering only to the regions of interest in an image that are identified by a binary mask. Filtered values are returned for pixels where the binary mask contains 1″s, while unfiltered values are returned for pixels where the binary mask contains 0″s.

In accordance with step 32 depicted in FIG. 2, the image processor then executes an image processing algorithm, i.e., carries out image processing operations (e.g., contrast enhancement, brightness enhancement or image filtering), on the first masked image, which, as previously explained, comprises image regions with the annotated regions masked out. The result of these operations is a processed image 22, which the image processor 18 outputs to the post-processor 24. In its broadest scope, the image processing envisioned by the invention encompasses any processing of the image regions that alters the pixel intensities.

In the post-processor 24, the processed grayscale image 22 (comprising the processed image regions) is merged, e.g., by summation of respective pixel intensity values, with the second masked image (comprising the original annotation regions) in step 34. The result is the processed image 36 with all annotations intact. The merged annotations occupy the same pixels in the merged image that the removed annotations originally occupied in the annotated image.

It should be appreciated that all of the above-described operations could be performed by a single general-purpose computer or by separate dedicated processors.

Different techniques can be used to remove the annotations from the annotated image. In accordance with one embodiment of the invention, the annotations are removed by a technique comprising morphology-based processing and thresholding. In accordance with another embodiment of the invention, the annotations are removed by a technique comprising a thresholded, connectivity-based analysis.

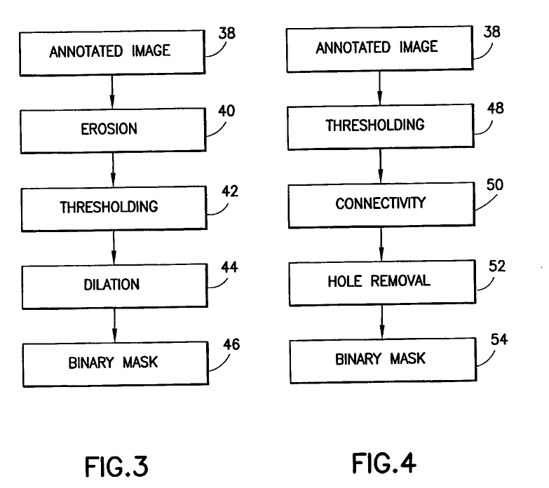

The morphology-based technique is depicted in FIG. 3. First, the grayscale annotated image 38 is subjected to grayscale erosion (step 40) using function set processing with a suitable two-dimensional structuring element. For grayscale erosion, the value of the output pixel is some function of the values of all the pixels in the input pixel″s neighborhood. For example, the value of the output pixel could be the minimum value of all the pixel values in the input pixel″s neighborhood. The structuring element consists of 0″s and 1″s. The center pixel of the structuring element, called the origin, identifies the pixel being processed. The pixels in the structuring element that contain 1″s define the neighborhood of the pixel being processed.

Grayscale erosion is followed by thresholding (step 42) of the eroded image to derive a first binary mask. For example, a pixel in the first binary mask is set to 1 if the value of the corresponding pixel in the eroded image is less than the threshold and set to 0 if the value is greater than or equal to the threshold. The first binary mask is then dilated (step 44) using the same structuring element that was used for grayscale erosion (step 40) to derive a second binary mask 46 that defines the image regions of the annotated image. In dilation of a binary image, if any of the pixels in the input pixel″s neighborhood is set to the value 1, the output pixel is set to 1.

The connectivity-based technique is depicted in FIG. 4. First, the grayscale annotated image 38 is subjected to thresholding (step 48) to derive a first binary mask. The threshold is selected in accordance with domain knowledge. An 8-connected analysis (step 50) is used to reject segments from the first binary mask that are smaller than a prespecified size. Connectivity defines which pixels are connected to other pixels. This produces a second binary mask defining the image region. If there are holes in the second binary mask due to the thresholding process, the holes can be eliminated (step 52) by inverting the second binary mask to derive a third binary mask; carrying out an 8-connected analysis with a prespecified size threshold to derive a fourth binary mask; and inverting the fourth binary mask to obtain the final binary mask 54 that defines the image regions.

The invention is further directed to a system comprising memory for storing a grayscale annotated image, a computer system for processing the annotated image in the manner described above, and a display monitor connected to said the system for displaying the merged image.

The invention also has application in the enhancement of color images. In the case where the color annotated images of interest are in hue-saturation-value (HSV) color space, the pre-processor 14 (se FIG.1) removes the hue and saturation components from the HSV color annotated image to derive a brightness component annotated image. Then the pre-processor removes any annotations from the brightness component annotated image, using one of the techniques disclosed above, to derive a modified image that is output to the image processor 18. The image processor 18 outputs a processed brightness component image (without annotations) to the post-processor 24, which merges the removed one or more annotations and the removed hue and saturation components with the processed brightness component image to derive a merged image.

In the case where the color annotated images of interest are in the RGB color space, the pre-processor 14 first converts the RGB color annotated image from RGB color space to HSV color space to derive an HSV color annotated image. Then the HSV color annotated image is processed as described in the previous paragraph.

While the invention has been described with reference to preferred embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for processing annotated images comprising the following steps:
removing one or more annotations from a grayscale annotated image to derive a first modified image;
processing said first modified image using an algorithm to derive a processed image; and
merging the removed one or more annotations with said processed image to derive a merged image.

2. The method as recited in claim 1, wherein said removing step comprises the following: deriving a first binary mask defining one or more image regions; and multiplying said first binary mask and said annotated image to derive said first modified image.

3. The method as recited in claim 2, wherein said merging step comprises the following: inverting said first binary mask to derive a second binary mask defining one or more annotation regions; multiplying said second binary mask and said annotated image to derive a second modified image; and merging said second modified image and said processed image to derive said merged image.

4. The method as recited in claim 1, wherein the merged annotations occupy the same pixels in said merged image that the removed annotations originally occupied in said annotated image.

5. The method as recited in claim 1, wherein said removing step comprises morphology-based processing and thresholding.

6. The method as recited in claim 1, wherein said removing step comprises the following: grayscale erosion of said annotated image using a structuring element to derive an eroded image; thresholding said eroded image to derive a first binary mask; dilation of said first binary mask using said structuring element to derive a second binary mask defining one or more image regions; and multiplying said second binary mask and said annotated image to derive said first modified image.

7. The method as recited in claim 6, wherein said merging step comprises the following: inverting said second binary mask to derive a third binary mask defining an annotation region; multiplying said third binary mask and said annotated image to derive a second modified image; and merging said second modified image and said processed image to derive said merged image.

8. The method as recited in claim 1, wherein said removing step comprises thresholding and pixel connectivity-based analysis.

9. The method as recited in claim 1, wherein said removing step comprises the following: thresholding the annotated image to derive a first binary mask; using 8-connected analysis to reject segments smaller than a prespecified size from said first binary mask to derive a second binary mask defining one or more image regions; and multiplying said second binary mask and said annotated image to derive said first modified image.

10. The method as recited in claim 9, wherein said merging step comprises the following: inverting said second binary mask to derive a third binary mask defining an annotation region; multiplying said third binary mask and said annotated image to derive a second modified image; and merging said second modified image and said processed image to derive said merged image.

11. The method as recited in claim 1, wherein said removing step comprises the following: thresholding the annotated image to derive a first binary mask; using 8-connected analysis to reject segments smaller than a prespecified size from said first binary mask to derive a second binary mask defining one or more image regions; removing holes from said second binary mask to derive a third binary mask; and multiplying said third binary mask and said annotated image to derive said first modified image.

12. The method as recited in claim 1, wherein said processing step comprises filtering to enhance said first modified image.

13. A computer system programmed to perform the following steps:
removing one or more annotations from a grayscale annotated image to derive a first modified image;
processing said first modified image using an algorithm to derive a processed image; and
merging the removed one or more annotations with said processed image to derive a merged image.

14. The system as recited in claim 13, wherein said removing step comprises the following: deriving a first binary mask defining one or more image regions; and multiplying said first binary mask and said annotated image to derive said first modified image.

15. The system as recited in claim 14, wherein said merging step comprises the following: inverting said first binary mask to derive a second binary mask defining one or more annotation regions; multiplying said second binary mask and said annotated image to derive a second modified image; and merging said second modified image and said processed image to derive said merged image.

16. The system as recited in claim 13, wherein said removing step comprises the following: grayscale erosion of said annotated image using a structuring element to derive an eroded image; thresholding said eroded image to derive a first binary mask; dilation of said first binary mask using said structuring element to derive a second binary mask defining one or more image regions; and multiplying said second binary mask and said annotated image to derive said first modified image.

17. The system as recited in claim 16, wherein said merging step comprises the following: inverting said second binary mask to derive a third binary mask defining an annotation region; multiplying said third binary mask and said annotated image to derive a second modified image; and merging said second modified image and said processed image to derive said merged image.

18. The system as recited in claim 13, wherein said removing step comprises the following: thresholding the annotated image to derive a first binary mask; using 8-connected analysis to reject segments smaller than a prespecified size from said first binary mask to derive a second binary mask defining one or more image regions; and multiplying said second binary mask and said annotated image to derive said first modified image.

19. The system as recited in claim 18, wherein said merging step comprises the following: inverting said second binary mask to derive a third binary mask defining an annotation region; multiplying said third binary mask and said annotated image to derive a second modified image; and merging said second modified image and said processed image to derive said merged image.

20. The system as recited in claim 13, wherein said removing step comprises the following: thresholding the annotated image to derive a first binary mask; using 8-connected analysis to reject segments smaller than a prespecified size from said first binary mask to derive a second binary mask defining one or more image regions; removing holes from said second binary mask to derive a third binary mask; and multiplying said third binary mask and said annotated image to derive said first modified image.

21. The system as recited in claim 13, wherein said processing step comprises filtering to enhance said first modified image.

22. A method for processing annotated images comprising the following steps:
removing the hue and saturation components from a HSV color annotated image to derive a brightness component annotated image;
removing one or more annotations from the brightness component annotated image to derive a first modified image;
processing said first modified image using an algorithm to derive a processed image; and
merging the removed one or more annotations and the removed hue and saturation components with said processed image to derive a merged image.

23. The method as recited in claim 22, wherein said removing step comprises the following: deriving a first binary mask defining one or more image regions; and multiplying said first binary mask and said annotated image to derive said first modified image.

24. The method as recited in claim 23, wherein said merging step comprises the following: inverting said first binary mask to derive a second binary mask defining one or more annotation regions; multiplying said second binary mask and said annotated image to derive a second modified image; and merging said second modified image and said processed image with said removed hue and saturation components to derive said merged image.

25. The method as recited in claim 22, further comprising the step of converting an RGB color annotated image from RGB color space to HSV color space to derive said HSV color annotated image.

26. A computer system programmed to perform the following steps:
removing the hue and saturation components from an HSV color annotated image to derive a brightness component annotated image;
removing one or more annotations from said brightness component annotated image to derive a first modified image;
processing said first modified image using an algorithm to derive a processed image; and
merging the removed one or more annotations and the removed hue and saturation components with said processed image to derive a merged image.

27. The system as recited in claim 26, wherein said removing step comprises the following: deriving a first binary mask defining one or more image regions; and multiplying said first binary mask and said annotated image to derive said first modified image.

28. The system as recited in claim 27, wherein said merging step comprises the following: inverting said first binary mask to derive a second binary mask defining one or more annotation regions; multiplying said second binary mask and said annotated image to derive a second modified image; and merging said second modified image and said processed image with said removed hue and saturation components to derive said merged image.

29. The system as recited in claim 26, further programmed to perform the step of converting an RGB color annotated image from RGB color space to HSV color space to derive said HSV color annotated image.

30. A computerized image enhancement system programmed to perform the following steps:
receiving a grayscale annotated image;
removing one or more annotations from said annotated image to derive a first modified image;
processing said first modified image using an algorithm to derive an enhanced image; and
merging the removed one or more annotations with said enhanced image to derive an annotated enhanced image.

31. The system as recited in claim 30, wherein said removing step comprises the following: deriving a first binary mask defining one or more image regions; and multiplying said first binary mask and said annotated image to derive said first modified image.

32. The system as recited in claim 31, wherein said merging step comprises the following: inverting said first binary mask to derive a second binary mask defining one or more annotation regions; multiplying said second binary mask and said annotated image to derive a second modified image; and merging said second modified image and said enhanced image to derive said annotated enhanced image.
